(19) United States
(12) Patent Application Publication
(10) Pub. No.: US 2010/0136326 A1
(43) Pub. Date: Jun. 3, 2010

(54) LAYER COMPOSITE AND PRODUCTION THEREOF

(75) Inventors: Markus Wolf, Freiburg (DE); Stefan Jaschke, Schaan (LI)

Correspondence Address: CANTOR COLBURN, LLP, 20 Church Street, 22nd Floor, Hartford, CT, 06103, US

(73) Assignee: SORTECH AG, HALLE (DE)

(21) Appl. No.: 12/063,477

(22) PCT Filed: Jul. 1, 2006
(86) PCT No.: PCT/EP06/06417

§ 371 Date: Oct. 5, 2009

(30) Foreign Application Priority Data
Aug. 10, 2005 (DE) 10 2005 038 044.1

(51) Int. Cl. B32B 15/04; B32B 5/16; F28F 13/18

(52) U.S. Cl. 428/331; 428/450; 428/336; 165/133

(57) ABSTRACT

The invention relates to a method for production of a layer composite, comprising a metal support substrate and a silicate layer with the following method steps: a) production of the metal support substrate, b) production of silicate crystals and/or silicate particles by means of solvothermal synthesis, said solvothermal synthesis being carried out in at least one ionic liquid and c) coating of at least one surface of the metal support substrate with the silicate crystals and/or silicate particles produced in b).

The present invention relates to a method for producing a layered amalgam comprising a metallic carrier layer and a silicate layer, and the usage of such layered amalgams in heat pump technology.

Silicates are salt forms of the orthosilicic acids Si(OH)₄ and their condensation products. They are not only the most diverse class of minerals; they are also of major technical importance. Glass, porcelain, enamel, earthenware, concrete and soluble glass are technically important products that are made of silicates.

Silicates can be divided into the following groups according to their structure: a) silicates with discrete anions like nesosilicates (inselsilicates, orthosilicates with anion [SiO₄]⁴⁻), sorosilicates (group-silicates, all [SiO₄]-tetrahedrons being combined in one finite group), cyclosilicates (ring silicates, where [SiO₄]-tetrahedrons form rings), b) inosilicates (chain and band silicates, where [SiO₄]-tetrahedrons form chains, i.e. one-dimensional unlimited shapes that can be seen as polymers of the anion [SiO₃]²⁻), c) phyllosilicates (sheet and compound silicates, where the [SiO₄]-tetrahedrons form a chain on one level, they form compound grids and can be seen as polymers of the anion [Si₄O₁₀]⁴⁻) and d) tectosilicates (frame silicates, where the [SiO₄]-tetrahedrons form three-dimensional networks). Zeolites and feldspars are technically the most important mineral silicates.

Zeolites are mineral silicates and especially aluminusilicates with a chemically complex structure which is characterized through the formation of porous tetrahedron networks. According to the general definition by IZA (International Zeolite Association) zeolites are minerals that form tetrahedron networks with a network density of more than 19 tetrahedron atoms per 1000 Å³. Zeolites have a structure with inner hollow spaces that will reach the size of a molecule. Therefore zeolites can incorporate foreign atoms or foreign molecules into their microporous structure, e.g. zeolites can save huge amounts of water and release it when they are heated up. Zeolite materials in contact with a heat exchanger can therefore be easily used to create a latent heat store. According to the prior art, fills of zeolite or materials containing zeolites that are poured into open-pored solids like metal sponges that are in thermal contact with a heat exchanger are used for this process. Please see DE 101 59 652 C2, for example, for this process.

Fills of zeolite are not suitable for applications that require heat addition to zeolites or heat removal from zeolite materials because the thermal contact to the neighbouring heat exchanging structures is insufficient. Furthermore, especially for latent heat stores, the working medium customarily referred to as sorptive must be added as sorb material to the zeolite in an effective manner. This requires macroscopic channel structures in the sorb material. For this reason the pulverised synthesized zeolite will be pressed into bigger units in the shape of pellets with the help of a binder for such purposes. Unfortunately most binders influence and change the relevant properties of zeolites in a negative way. In addition, the usage of pellets does not guarantee enough thermal contact to neighbouring heat exchangers. For this reason the usage of systems of heat exchangers to which a zeolite coating is applied is recommended. Typically, in known processes for coating substrates with zeolites there is first a synthesis interval where the zeolite material is created. This zeolite material can be treated mechanically afterward, e.g. it can be ground or reduced in size, so that a powdered zeolite is created. Afterward the pre-synthesised zeolite material will be mixed with a binder and coated onto the carrier substrate.

However, it is very difficult to coat the whole surface of the heat exchanger with a zeolite coating of uniform thickness, especially on complex three-dimensional heat exchange structures. Furthermore, such a post synthesis coating process consists of many production steps. In addition, most binders change the properties of zeolites because the molecules that are to be bound do not have free access to the inner microporous structure of the zeolite particles.

A number of suggestions have been made with regard to the synthesis of silicates in the literature. The most interesting ones are the sol-gel synthesis procedure and hydrothermal synthesis. Hydrothermal synthesis is generally the synthesis of minerals and chemical compounds through crystallization of highly-heated aqueous solutions, i.e. hydrothermal solutions with a temperature of more than 100° C. and a pressure of more than 1 bar. In most cases hydrothermal synthesis is carried out in pressure containers because the temperatures used to carry out the process are far higher than the boiling point of water, most even above its critical temperature of T_{K}=374° C. In its supercritical state water dissolves some water-insoluble materials. The increased ability to dissolve is most likely derived from compression because the smaller physical distance increases the interaction with the dissolved material. Therefore there is a possibility for producing mesoscopic inorganic colloids, crystals or powders in aqueous systems during hydrothermal synthesis. This synthesis generally produces particles having a diameter of only a few μm.

Apart from these procedures that have been known for some time, a new process for producing silicate coatings through a spin coating procedure has recently emerged. The production of porous coatings, porous coatings themselves and the use of these coatings in microelectronics are described in WO 02/032 589 A1. The coatings can consist of periodically porous particles of one zeolite where the particles have a diameter of only a few nanometers and the coatings have a thickness of 30 to 1000 nm. The described coatings are applied to a silicon surface.

A major problem in the hydrothermal synthesis of silicates is nucleation, which determines the morphology and the particle size distribution of the formed particles. In thermodynamic terms the formation of seed crystals and generally all crystals or particles represents a phase formation and is therefore subject to its own specific laws. Due to entropy decrease it is highly unlikely that a spontaneous formation of particles will occur because particles consist of a number of particles. Therefore a precipitation or a formation of particles, powders or crystals always requires an induction phase in which the primary seed crystals are formed. A broad particle size distribution and an energetically minimized particle surface are the result if the formation of seed crystals during the induction phase is slow. If the formation of seed crystals is fast, growth will be homogeneous, particle size will be small, and size distribution will be narrow.

The processes of nucleation in solution and/or on the substrate, transportation of seed crystals onto the surface and their most homogeneous, lateral growth on the substrate surface are necessary requirements for the precipitation of dense silicate coatings on a metallic substrate during hydrothermal synthesis.

Therefore one object of the present invention is to offer a process that can produce an even and homogeneous coating of a metallic carrier with silicates within a short coating time. A further object of the invention is to offer a process for creating a silicate coating that consists of individual particles with a very narrow particle size distribution. Moreover, a lateral homogeneous precipitation of thick silicate coatings on a metallic substrate that can be achieved directly shall be offered. Another object of the invention is to offer a layered amalgam that can be produced using a cost-effective method.

These objects are attained with a process for the production of a layered amalgam made up of a metallic carrier substrate and a silicate coating, comprising the following process steps: a) preparation of the metallic carrier substrate, b) production of silicate crystals and/or silicate particles through solvo-thermal synthesis in at least one ionic liquid and c) coating of at least one surface of the metallic carrier substrate with the silicate crystals and/or silicate particles produced in b).

Here and in what follows, a solvo-thermal synthesis is a hydrothermal analogue synthesis in a solvent other than water, where the temperature and pressures are regulated according to the various solvents. In this context a coating is a continuous substance layer that covers a whole area with only very few surface defects. Further, an ionic liquid is a salt which is liquid at room temperature and is made up of a complex inorganic cation or an organic cation containing nitrogen, oxygen, sulphur, phosphorous or other homologs as the heteroatom, and inorganic or organic anions. Cation and anion can be formed through derivatization in such a way that they require a lot of room and extend the area of existence of the solution. These ionic liquids have very low melting points because they are salts. In addition, ionic liquids have broad thermal fluid area and good thermal stability and are hydrolysis-resistant. Because of their physicochemical properties as melted salts, i.e. because cations and anions without solvate shells are freely movable, ionic liquids generally have no intrinsic vapour pressure in thermal stability. It is as yet unclear whether in isolated cases pairs of ions or even single ions can be vaporized from the solution into the gas phase through thermal excitation. An overview of the types and properties of ionic fluids can be found in P. Wasserscheid, T. Welton “Ionic Liquids in Synthesis” Wiley VCH 2003.

Surprisingly it has been discovered that nucleation is achieved 1000 times faster if at least one ionic liquid is used as solvent in the solvothermal synthesis of silicates, in comparison with the known hydrothermal synthesis. Therefore, if an ionic liquid and not water is used as the solvent in the synthesis of silicate crystals and/or silicate particles, significantly shorter synthesis times are possible, corresponding to about half the synthesis time in water. In addition, if at least one ionic liquid is used as the solvent, the equipment that is more involved in terms of security technology as compared with the known hydrothermal synthesis is not necessary. Because of lower pressures in general the security equipment necessary for high pressures is not needed. It was also surprising to see that the synthesis of undesired species that can be found in an aqueous environment or when water is used as the solvent can be suppressed to a large extent. Another advantage of the use of ionic liquids as the solvent in the solvothermal synthesis of silicates is that the choice of anions and cations of ionic liquids adds properties to the solution that can be achieved in hydrothermal synthesis only through the combination of water as solvent and dissolved neutral molecules or electrolytes.

According to a second preferred process, the synthesis of silicate crystals and/or silicate particles is carried out in a mixture of at least two different ionic liquids.

The ionic liquid or the mixture of at least two different ionic liquids used according to the invention will preferably contain at least one salt made up of a hydrophilic or hydrophobic anion X, particularly a hydrophilic or hydrophobic univalent, divalent or trivalent anion X^{m-} with m=1, 2 or 3 and a five- or six-sided, aromatic, partially saturated or unsaturated, nitrogen-containing heterocyclene-cation, an ammonium cation or a guanidinium cation. Especially, the salt can be a pyrrolium salt [Formula (I)], imidazolium salt [Formula (II)], imidazolidinium salt [Formula (III), pyridinium salt [Formula (IV)], ammonium salt [Formula (V)] or a guanidinium salt [Formula (VI)] with the following structures:

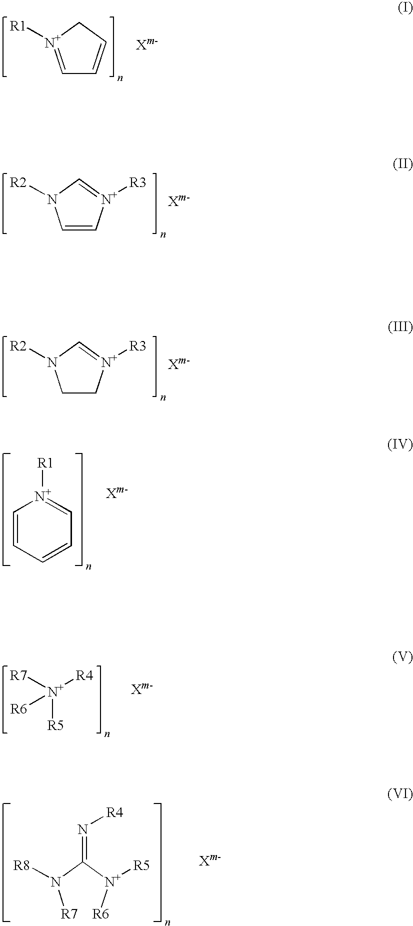

wherein X^{m-} is a mono-, di- or trivalent anion with m=1,2 or 3, wherein n is the number of monovalent cations in the salt and has the value n=1, 2 or 3, and n represents the valence of the anion, wherein R1 can be an alkyl, alkene or aryl group, wherein R2 and R3 can be equal to or different from hydrogen, an alkyl, alkene or aryl group, with the measure that R2 and R3 have the same or different meanings, and at least one group of R2 or R3 is an alkyl, alkene or aryl group,

wherein R4, R5, R6, R7 and R8 can be equal to or different from hydrogen, an alkyl, alkene or aryl group with the measure that at least one group R4, R5, R6, R7 or R8 is an alkyl, alkene or aryl group, and that R4, R5, R6, R7 and R8 can have the same or different meanings.

In particular, the ionic liquid or the mixture of at least two ionic liquids can thereby comprise at least one salt, having a hydrophilic or hydrophobic anion X, especially a mono-, di- or trivalent X^{m-} anion with m=1, 2 or 3 and as a cation a five or six-sided, aromatic, partially saturated or unsaturated, nitrogen-containing heterocyclene cation, an ammonium cation or a guanidinium cation according to one of the formulas I to VI.

wherein n is the number of monovalent cations in the salt and has the value n=1, 2 or 3, and n corresponds to the valence of the anion, wherein R1 can be an alkyl, alkene or aryl group, wherein R2 and R3 are equal to or different from hydrogen, an alkyl, alkene or aryl group, with the measure that R2 and R3 can have the same or different meanings, and at least one group R2 or R3 is an alkyl, alkene or aryl group, wherein R4, R5, R6, R7 and R8 are equal to or different from hydrogen, an alkyl, alkene or aryl group with the measure that at least one group R4, R5, R6, R7 or R8 is an alkyl, alkene or aryl group and that R4, R5, R6, R7 and R8 can have the same or different meanings, and wherein the alkyl group or alkene group is a linear, branched, saturated and/or unsaturated alkyl group with a carbon chain length of C-1 to C-30 and especially preferably is a methyl-, ethyl-, n-propyl-, 1-methylethyl-, n-butyl-, 1-methylpropyl-, 2-methylpropyl-, 1,1-dimethylethyl-, n-pentyl-, 1-methylbutyl-, 2-methylbutyl-, 3-methylbutyl-, 1-ethylpropyl-, 2-ethylpropyl-, 1,1-dimethylpropyl-, 1,2-dimethylpropyl-, 2,2-dimethylpropyl-, n-hexyl-, 2-ethylhexyl-, n-heptyl-, n-octyl-, n-nonyl-, n-decyl-, n-undecyl- or n-dodecyl group.

In the invented process the preferred implementation of ionic liquid or the mix of at least two ionic liquids includes at least one salt, comprising a mono- di- or trivalent X^{m-} anion with m=1, 2 or 3, and as a cation a five- or six-sided, aromatic, partially saturated or unsaturated, nitrogen-containing heterocyclene cation, an ammonium cation or a guanidinium cation, as shown in one of the formulas I to VI,

wherein n is the number of monovalent cations in the salt and has the value n=1, 2 or 3, and n corresponds to the valence of the anion, wherein R1 can be an alkyl, alkene or aryl group, wherein R2 and R3 can be equal to or different from hydrogen, an alkyl, alkene or aryl group, with the measure that R2 and R3 can have the same or different meanings, and at least one group R2 or R3 is an alkyl, alkene or aryl group,

wherein R4, R5, R6 , R7 and R8 can be equal to or different from hydrogen, an alkyl, alkene or aryl group, with the measure that at least one group R4, R5, R6, R7 or R8 is an alkyl, alkene or aryl group, and that R4, R5, R6, R7 and R8 can have the same or different meanings, and wherein X^{m-} is an anion from the group tetrafluoro borate (BE₄⁻), alkyl borate, especially tetraalkyl borate (B(OR)₄⁻ with R=alkyl), especially triethylhexyl borate (C₂H₆O)₃(C₆H₁₂O)B⁻) phosphate (PO₄³⁻), halogeno phosphate especially hexafluoro phosphate (PF₆⁻), organic phosphates especially alkyl phosphates or aryl phosphates (RO—PO₃⁻ with R=alkyl or aryl), nitrate (NO₃⁻), sulphate (SO₄²⁻), organic sulphates, especially alkyl sulphates or aryl sulphates (ROSO₃⁻ with R=Alkyl or Aryl), organic sulfonates especially alkyl sulfonates or aryl sulfonates (R—SO₃⁻ with R=Alkyl or aryl), especially toluol sulfonyl (p-CH₃(C₆H₄)—SO₃), carboxylate (R—COO⁻ with R=alkyl), methanide ([HCR⁸R⁹] and [CR⁸R⁹R¹⁰] with R⁸, R⁹, R¹⁰═CN, NO or NO₂, wherein R⁸, R⁹, R¹⁰ can be the same or different), halogen, especially fluoride (F⁻), chloride (Cl⁻) or bromide (Br⁻) or pseudohalogenide especially azide (N₃⁻), cyanide (CN⁻), cyanate (OCN⁻), fulminate (R₂CNO⁻) with R=Alkyl or Aryl) or thiocyanate (SCN⁻) and wherein especially each alkyl group R of the X^{m-} anions or, if two alkyl groups R are provided, each alkyl group R of the X^{m-} anions is the same or different linear, branched, saturated and/or unsaturated alkyl group with a carbon chain length of C-1 to C-30, and especially preferably a methyl-, ethyl-n-propyl-, 1-methylethyl-, n-butyl-, 1-methylpropyl-, 2-methylpropyl-, 1,1-dimethylethyl-, n-pentyl-, 1-methylbutyl-, 2-methylbutyl-, 3-methylbutyl-, 1-ethylpropyl-, 2-ethylpropyl-, 1,1-dimethylpropyl-, 1,2-dimethylpropyl-, 2,2-dimethylpropyl-, n-hexyl-, 2-ethylhexyl-, n-heptyl-, n-octyl-, n-nonyl-, n-decyl-, n-undecyl- or n-dodecyl group.

It is further preferred that the ionic liquid is comprised of 1,3-dialkylimidazolium cations and a hydrophilic or hydrophobic anion X, especially a mono-, di- or trivalent X^{m-} anion with m=1, 2 or 3 according to Formula II,

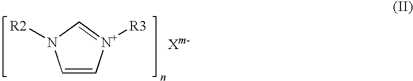

wherein n is the number of monovalent cations in the salt and has the value n=1, 2 or 3, and n corresponds to the valence of the anions, wherein R2 and R3, independently of one another, can be a linear, branched, saturated and/or unsaturated alkyl group with a carbon chain length from C-1 to C-30, and wherein X^{m-} is an anion from the group tetrafluoro borate (BF₄⁻), alkyl borate (B(OR)₄⁻ with R=alkyl), phosphate (PO₄³⁻), halogeno phosphate (PY₆ with Y=halogen), alkyl or aryl phosphate (RO—PO₃⁻ with R=alkyl or aryl), nitrate (NO₃⁻), sulphate (SO₄²⁻), alkyl or aryl sulphates (RO—SO₃⁻ with R=alkyl or aryl), alkyl or aryl sulfonates (R—SO₃⁻ with R=alkyl or aryl), carboxylate (R—COO⁻ with R=alkyl), methanide ([HCR⁸R⁹]⁻ and [CR⁸R⁹R¹⁰]⁻ with R⁸, R⁹, R¹⁰═CN, NO or NO₂, wherein R⁸, R⁹, R¹⁰ can be the same or different), fluoride (F⁻), chloride (Cl⁻), bromide (Br⁻), azide (N₃⁻) cyanide (CN⁻), cyanate (OCN⁻), fulminate (R₂CNO⁻ with R=alkyl or aryl) or thiocyanate (SCN⁻), and wherein each alkyl group R of the X^{m-} anions or, if two alkyl groups R are provided, each alkyl group R of the X^{m-} anions is the same or different linear, branched, saturated and/or unsaturated alkyl group with a carbon chain length of C-1 to C-30.

It can especially also be preferred that the ionic liquid or the mixture of at least two ionic liquids is comprised of 1,3-dialkyl imidazolium cations (Formula II, wherein R2, R3, independently of one another, are alkyls) and a hydrophilic or hydrophobic X anion, especially mono-, di- or trivalent anions X^{m-} with m=1, 2 or 3,
wherein alkyl means, independently of one another, a linear, branched, saturated and/or unsaturated alkyl group with a carbon chain length from C-1 to C-30, and especially means methyl-, ethyl- n-propyl-, 1-methylethyl-, n-butyl-, 1-methylpropyl-, 2-methylpropyl-, 1,1-dimethylethyl-, n-pentyl-, 1-methylbutyl-, 2-methylbutyl-, 3-methylbutyl-, 1-ethylpropyl-, 2-ethylpropyl-, 1,1-dimethylpropyl-, 1,2-dimethylpropyl-, 2,2-dimethylpropyl-, n-hexyl-, 2-ethylhexyl-, n-heptyl-, n-octyl-, n-nonyl-, n-decyl-, n-undecyl- or n-dodecyl, and
wherein X^{m-} is especially an anion from the group tetrafluoro borate (BF₄⁻), alkyl borate, especially tetraalkyl borate (B(OR)₄⁻ with R=alkyl), especially triethylhexyl borate (C₂H₆O)₃(C₆H₁₂)B⁻), phosphate (PO₄³⁻), halogeno phosphate especially hexafluoro phosphate (PF₆⁻), organic phosphates especially alkyl phosphates or aryl phosphates (RO—PO₃⁻ with R=alkyl or aryl), nitrate (NO₃⁻), sulphate (SO₄²⁻), organic sulphates, especially alkyl sulphate or aryl sulphate (ROSO₃⁻ with R=alkyl or aryl), organic sulfonates, especially alkyl sulfonates or aryl sulfonates (R—SO₃⁻ with R=alkyl or aryl), most especially toluol sulfonyl (p-CH₃(C₆H₄)—SO₃⁻), carboxylate (RCOO⁻ with R=alkyl), methanide ([HCR⁸R⁹]⁻ and [CR⁸R⁹R¹⁰]⁻ with R⁸, R⁹, R¹⁰═CN, NO or NO₂, wherein R⁸, R⁹, R¹⁰ can be the same or different), halogen, especially fluoride (F⁻), chloride (Cl⁻) or bromide (Br⁻) or pseudohalogenide especially azide (N₃⁻) cyanide (CN⁻), cyanate (OCN⁻), fulminate (R₂CNO⁻ with R=alkyl or aryl) or thiocyanate (SCN⁻), and wherein especially each alkyl group R of the anions X^{m-} or, if two alkyl groups R are provided, each alkyl group R of the anions X^{m-} is the same or a different linear, branched, saturated and/or unsaturated alkyl group with a carbon chain length of C-1 to C-30 and further is especially preferably a methyl-, ethyl- n-propyl-, 1-methylethyl-, n-butyl-, 1-methylpropyl-, 2-methylpropyl-, 1,1-dimethylethyl-, n-pentyl-, 1-methylbutyl-, 2-methylbutyl-, 3-methylbutyl-, 1-ethylpropyl-, 2-ethylpropyl-, 1,1-dimethylpropyl-, 1,2-dimethylpropyl-, 2,2-dimethylpropyl-, n-hexyl-, 2-ethylhexyl-, n-heptyl-, n-octyl-, n-nonyl-, n-decyl-, n-undecyl- or n-dodecyl group.

According to an especially preferred process, the ionic liquid or the mixture of at least two ionic liquids is comprised of a minimum of one 1-alkyl-3-methylimidazolium halogenide [Formula (II) wherein R3=methyl and R2=alkyl], wherein alkyl means a linear or branched, saturated carbon with a carbon chain length from C-1 to C-30, and especially is a methyl-, ethyl- n-propyl-, 1-methylethyl-, n-butyl-, 1-methylpropyl-, 2-methylpropyl-, 1,1-dimethylethyl-, n-pentyl-, 1-methylbutyl-, 2-methylbutyl-, 3-methylbutyl-, 1-ethylpropyl-, 2-ethylpropyl-, 1,1-dimethylpropyl-, 1,2-dimethylpropyl-, 2,2-dimethylpropyl-, n-hexyl-, 2-ethylhexyl-, n-heptyl-, n-octyl-, n-nonyl-, n-decyl-, n-undecyl- or n-dodecyl group, and wherein halogenide is chloride or bromide.

There are further possibilities for anion-cation combinations which can be suitable for ionic liquid. In particular, through the systematic combination of anion and cation salts, ionic liquids as solvothermal solvent phases can be produced with specific properties, such as, for example, a melting point and thermal stability. In a preferred variant of the invention the ionic liquid represents a Bronsted acid and/or its salt, and serves thereby as a proton/cation source and/or contains a Bronsted acid and/or its salts, which serve as a proton/cation source.

In addition, it can further be foreseen that the ionic liquid or the mixture of at least two ionic liquids additionally comprises promoter ions, wherein these are selected from the group of phosphate (PO₄³⁻), organic phosphates (RO—PO₃⁻), nitrate (NO₃⁻), sulphate (SO₄²⁻), organic sulphates (RO—SO₃⁻), carboxylate (R-COO⁻), methanide ([HCR⁸R⁹]⁻ or [CR⁸R⁹R¹⁰]⁻ with R⁸, R⁹, R¹⁰═CN, NO or NO₂, wherein R⁸, R⁹, R¹⁰ can be the same or different), fluoride (F⁻), chloride (Cl⁻), bromide (Br⁻), azide (N₃⁻), cyanide (CN⁻), cyanate (OCN⁻), fulminate (R₂CNO⁻) or thiocyanate (SCN⁻). In particular, the organic groups R can be an alkyl residue. These promoter ions can be added as an additive to an ionic liquid in any form, i.e. independent of an attached counterion.

In ionic liquids, inorganic syntheses and especially silicate syntheses can be conducted under relatively mild conditions, which lead to a targeted synthesis of silicates with defined structural components. On one hand, synthesis can be carried out under temperatures that are below a specific level; the synthesis can especially be conducted at a temperature under 250° C., especially under 200° C. and especially preferably between 50° C. and 150° C. On the other hand, the synthesis can be carried out in a water-free or controlled water-containing environment. In an especially preferred process, synthesis is carried out in a controlled water-containing environment, wherein the amount of water is at most double the amount of the stoichiometric parts of water based upon the quantity necessary for the synthesis of the respective silicates. In such a reaction medium, secondary reactions, which take place in a hydrothermal synthesis based upon system conditions, is almost completely suppressed, whereby a nearly optimal reaction condition for targeted synthesis is made available. Afterwards, in a preferred method of the invention, the synthesis of silicates is performed at the highest at 150° C. and especially 50° C. to 150° C. and especially in an autoclave at 50° C. to 150° C. In particular the synthesis of silicates is carried out in an autoclave at 50° C. to 150° C. and with a quantity of water that is at most double the stoichiometric quantity in relation the silicate to be synthesized. The autoclave is a closed vessel which remains closed during the entire reaction time, so that the total pressure established with the dialled-in temperature is maintained. With this, the solvothermal conditions are established in a very simple way. Through the use of ionic liquids as solvents and the controlled amount of water, the high-pressure autoclaves that are necessary for hydrothermal synthesis can be dispensed with.

In addition, it can be foreseen that the solvothermal synthesis can be carried out in an autoclave system with convection. This convection establishes a laminar flow on the metallic carrier substrate surface. Through this, the surface is supplied with an especially even concentration of synthesized silicates, or with the even concentration of dissolved components established with the laminar flow, a very uniform growth of silicates on the metal surface results. This represents a significant difference from the classic hydrothermal synthesis, in which only a material transport through convection in a gravity field is ensured, which is supported by an internal stirring process, which does not for its part lead to a laminar flow. In particular, this is a process in which the process steps (b) and (c) can be carried out at the same time. In an especially preferred process the synthesis of the silicates follows process step (b) and the coating follows process step (c) in a multi-chamber autoclave, so that the process steps (b) and (c) can be carried out at the same time. A multi-chamber autoclave is understood to be a pressure vessel which has at least two compartments, wherein each compartment is isothermically isolated from the remaining compartments. In a first compartment, the metal carrier substrate is brought in, whereas in the at least second compartment a convection current is present, through which a laminar current is generated on the surface of the metal carrier substrate. With this, there can be a fast nuclear build-up at each point in the ionic liquid caused by the ionic liquid, and these nuclei can be placed in a very uniform concentration on the metallic surface, and/or a very homogenous nuclear formation can take place on the metallic surface. This homogeneous nuclear formation in the ionic liquid and/or on the metallic surface of the carrier substrate causes a growth of homogenous silicate layers on the metal surface.

In the manufacture of the particles, crystals or the resulting or in-situ constructed layers, the ionic liquids can further be used as stabilizing agents on the surface of the growing particles. Anionic or cationic constructed parts can thereby take over the role as stabilisers, which in the classic systems are added as molecular additives. In this way, solvothermal systems can be built, which significantly extend the property and application spectrum of classic water-based systems.

With the method recommended here, a layered amalgam can be produced whose silicate layer is very homogeneous with regard to its layer thickness at each part of the layered amalgam, and in addition is very homogeneous with regard to the individual particles from which the silicate layer is made. Through the faster nucleus build-up, as compared with classic hydrothermal synthesis, the nucleus build-up is easier in comparison with particle or crystal growth. Therefore, particles or crystals and layers result from the recommended process, which have a very narrow particle size distribution. This narrow particle size distribution in turn guarantees a homogeneous silicate layer on the metal carrier substrate. A cohesive silicate layer will therefore be attained by newly formed nuclei growing on already established nuclei on the metal carrier substrate.

Accordingly, in a preferred method an especially homogeneous silicate layer can have a layer thickness of at least 10 microns, especially 10 microns and at the highest 200 microns, and most especially at least 50 microns and at the highest 150 microns. In a further preferred method, the silicate layer has particles or crystals that have a particle diameter of at most 200 nm, especially 10 to 150 nm.

In keeping with the classic synthesis method for silicates and especially for zeolites, the starting materials necessary for the build-up of the silicate structure or the zeolite structure are placed in an aqueous solution or suspension. Such an aqueous suspension comprises a first component, which is a source for cations from the first or second main group of the Periodic Table, and water. In addition, there is a second component, which is a source for at least a network building element from the third, fourth or fifth main group of the Periodic Table. The amount of water in the solution or suspension is chosen such that at most a double stoichiometric quantity that corresponds to the silicate to be synthesized is present.

In particular, with the above-mentioned new method, a synthesis of aluminium silicates and especially of zeolites of the general formula (VII) can be carried out:

M₂/_{z}O·Al₂O₃₋ₓSiO₂·yH₂O (VII)
wherein M: is one or more as a cation from the group of alkali or alkaline-earth elements, hydrogen and/or ammonia,
Z: is the valence of the cation or the total of the valences of the cations,
X: is 1.8 to 12, and
Y: is 0 to 8.

The further synthesis conditions for the manufacture of durable silicate layers or zeolite layers on the metal carrier substrate can be chosen within the framework of the expert measurement according to the classic silicate synthesis. In this, as the metallic carrier substrates especially a metallic substrate made of copper, aluminium, iron, alloys of these, or stainless steel should be chosen.

With the above-described invention, a layered amalgam is further produced via the above-described process. This layered amalgam can especially be used in a heat exchanger. Accordingly, with the present invention a heat exchanger is also recommended, which is produced using the above-described process. These layered amalgams are especially characterized by an effective energy transfer in a heat exchanger.

In particular, with the present invention a heat exchanger is also proposed, which has a metallic carrier substrate and a silicate layer, which in turn contains silicate particles or silicate crystals, which have a maximal particle size of 200 nm, especially maximally 150 nm and especially preferably a particle size of 50 to 150 nm.

In what follows, the method will be detailed with reference to an exemplary embodiment.

1. Method for the manufacture of a layered amalgam comprising a metallic carrier substrate and a silicate layer, the method comprising:
preparing the metallic substrate;
producing silicate crystals and/or silicate particles using solvothermal synthesis;
coating at least one surface of the metallic carrier substrate with the silicate crystals and/or silicate particles;
wherein the solvothermal synthesis is carried out in at least one ionic liquid.

2. Method according to claim 1 wherein the synthesis is carried out in a mixture of at least two different ionic liquids.

3. Method according to claim 1 or wherein the ionic liquid comprises 1,3-dialkylimidazolium cations and hydrophilic or hydrophobic anions X, especially mono-, di-or trivalent anions X^{m-} with m=1, 2 or 3, wherein alkyl, independently of one another, refers to a linear, branched, saturated and/or unsaturated alkyl group with a carbon chain length of C-1 to C-30.

4. Method according to claim 1 wherein the ionic liquid comprises at least a 1-alkyl-3-methylimidazolium halogenide, wherein alkyl refers to a linear or branched and/or saturated or unsaturated hydrocarbon with a carbon chain length of C-1 to C-30, and wherein halogenide means chloride or bromide.

5. Method according to claim 1 wherein the ionic liquid further comprises promoter ions, which are different from the anions of the ionic liquids, and that these promoter ions comprise phosphate (PO₄³⁻), organic phosphates (RO—PO₃⁻), nitrate (NO₃⁻), sulphate (SO₄²⁻), organic sulphates (RO—SO₃⁻), carboxylate (R—COO⁻), methanide ([HCR⁸R⁹]⁻ and [CR⁸R⁹R¹⁰]⁻ with R⁸, R⁹, R¹⁰═CN, NO or NO₂, wherein R⁸, R⁹, R¹⁰ can be the same or different), fluoride (F⁻), chloride (Cl⁻), bromide (Br—), azide (N₃⁻), cyanide (CN⁻), cyanate (OCN⁻), fulminate (R₂CNO⁻) and/or thiocyanate (SCN⁻).

6. Method according to claim 1 wherein the synthesis of silicate crystals and/or silicate particles is conducted in an autoclave at a maximum of 150° C. in the form of a solvothermal synthesis in an autoclave with convection current.

7. Method according to claim 1, wherein said producing the silicate crystals and/or silicate particles and said coating the carrier substance are performed at the same time.

8. Method according to claim 1, wherein the metallic substrate is made of copper, aluminium, iron, alloys of these, or stainless steel.

9. Method according to claim 1, wherein the silicate layer comprises an aluminium silicate comprising a zeolite of the general formula
M₂/₂O·Al₂O₃-xSiO₂·yH₂O (VII)
wherein M: is one or more a cation from the group of alkali or alkaline-earth elements, hydrogen and/or ammonia,
Z: is the valence of the cation or the sum of the values of the cations,
X: is 1.8 to 12, and
Y: is 0 to 8,

10. Method according to claim 1, wherein the silicate layer comprises silicate crystals and/or silicate particles which have a maximum particle diameter of 200.

11. Method according to claim 1, wherein that the silicate layer has a layer thickness of at least 10 microns.

12. Layered amalgam produced according to claims 1.

13. Heat exchanger comprising a layered amalgam produced according to claim 1.

14. Layered amalgam according to claim 12 configured for energy exchange in a heat exchanger.
